(19) United States
(12) Patent Application Publication
(10) Pub. No.: US 2005/0195916 A1
(43) Pub. Date: Sep. 8, 2005

(54) Clipping technique for bursty complex and real signal

(76) Inventor: Kiomars Anvari, Alamo, CA (US)

Correspondence Address: Kiomars Anvari, 1567 Serafix Rd., Alamo, CA, 94507, US

(21) Appl. No.: 10/792,635

(22) Filed: Mar. 4, 2004

(51) Int. Cl. H04L 27/04

(52) U.S. Cl. 375/295

(57) ABSTRACT

A clipping technique for burst complex signal is described. The clipping is performed on the in phase “I” and quadrature phase “Q” of the complex signal. The technique uses the ratio of the rolling average as well as instantaneous value of the complex signal amplitude to calculate the amount of clipping. A third parameter in calculating the amount of the clipping is the absolute value of the rolling average of the complex signal amplitude. The rolling average is only calculated during the presence of the burst of the complex signal which is simply identified by the instantaneous value of the complex signal amplitude. The clipping value is stored in look up table which has two dimensions. One dimension is the ratio of the instantaneous and rolling average of the complex signal amplitude and the other dimension is absolute value of the rolling average of the complex signal amplitude. By multiplying the in phase “I” and quadrature “Q” of the complex signal with the clipping value the instantaneous amplitude of the complex signal is clipped without distorting the phase of the complex signal. The clipped “I” and “Q” signals are then filtered to remove the unwanted signal from the spectrum. The low pass filter has a flat amplitude and group delay bandwidth equal to the 99% occupancy bandwidth of the original complex signal before being clipped.

### BACKGROUND OF INVENTION

The present invention relates to a technique for clipping burst complex signal. The technique can be applied to both digital or analog signals. The in phase “I” and the quadrature phase “Q” of the complex signal are clipped without changing the phase of the complex signal. The clipping can be applied to bursty complex signals as well as real signal. In the case of real signal the quadrature “Q” component is zero. The clipping is based on rolling average, instantaneous value of the amplitude of the complex signal as well as absolute value of the rolling average of amplitude. In any wireless communication system one of the critical components is the power amplifier. This component has a major contribution in cost, power consumption, and size of the system. The main reason is the requirement of wireless radio communication system for linear power amplifiers. The higher the linearity, the higher the power consumption, cost and size. In order to minimize the cost, size and power consumption there is a need for techniques that overcome this problem. This invention conquers these challenges by using a simple and accurate peak suppression using a novel amplitude clipping technique.

### SUMMARY OF INVENTION

According to the invention, an amplitude clipping technique, used for bursty complex and real signals, uses a plurality of simple and accurate circuits in conjunction with intelligent signal processing to reduce the peak to average ratio without disturbing the properties of the complex or real signal. By intelligent, it is meant that amplitude clipping has features of adaptability to the input samples, such as ability to consider the changes due to average and instantaneous value of the complex or real signal. The amplitude clipping can be applied to complex baseband and real IF or RF signal. The conditioning or amplitude clipping helps to decrease the signal crest factor or peak to average ratio and ease the linearity requirements for various circuits that the signal is applied to. The conditioning is based amplitude clipping using the rolling average and instantaneous value of the signal. The input to the amplitude clipping circuit or function should be within a limit that can be handled by the circuit or function.

In a particular embodiment, amplitude clipping circuit or function comprises a rolling average calculation, an instantaneous value calculation, a look up table containing the clipping value, multipliers, and low pass filter. The rolling average calculates the average of the complex or real signal. The look up table takes the rolling average and the instantaneous of the signal to define the amount of clipping and the clipping multiplier factor. The multiplier take the output of the look up table and multiply by the real signal or the in phase “I” and quadrature “Q” of the complex signal. The clipped real and complex signal are then filtered to remove the unwanted signals. In case of the complex signal the “I” and “Q” signals are individually filtered. When the signal is real the filtering is at the frequency of the signal whether baseband, or higher frequency. If it is not baseband then the filter is a band pass filter.

The invention will be better understood by reference to the following detailed description in conjunction with the accompanying drawings.

### BRIEF DESCRIPTION OF THE DRAWINGS

FIG. 1 is an overall block diagram of the a transmitter with an amplitude clipping function.

FIG. 2 is the detail block diagram of the amplitude clipping function

FIG. 3 is the detail block diagram of an alternative implementation of the amplitude clipping function.

FIG. 4 is the block diagram of the low pass filter used for the amplitude clipping function

### DESCRIPTION OF THE SPECIFIC EMBODIMENTS

In a first preferred embodiment of the invention the amplitude clipping function uses the rolling average and the instantaneous of the amplitude of the complex signal to be used by a look up table. In a second embodiment the look up table uses the rolling average and the instantaneous value of the amplitude of the complex signal to define the amount of the clipping of the complex signal. In a third embodiment the look up table also uses the absolute value of the amplitude rolling average to determining the clipping amount. In a fourth embodiment the amplitude clipping factor is multiplied with the “I” and “Q” of the complex signal to avoid any phase distortion. In a fifth embodiment the clipped “I” and “Q” signals are low pass filtered to remove the unwanted signals from the amplitude clipped complex signal. In a sixth embodiment the low pass filter bandwidth is higher or equal to the Nyquist bandwidth times one plus the roll off factor of the original baseband filter used to filter the “I” and “Q” signals. In a seventh embodiment the instantaneous of the signal amplitude is used to determine the presence of the burst. In an eight embodiment the instantaneous of the signal amplitude is used to determine the presence of the bust is with some programmable delay depending on the number of the samples per symbol. In a ninth embodiment an alternative amplitude clipping solution calculates the instantaneous amplitude and phase of the complex signal. In a tenth embodiment the instantaneous phase of the signal stays unchanged and the instantaneous amplitude of the signal is clipped if exceeds a predefined threshold. In an eleventh embodiment the complex signal is reconstructed using it phase and clipped amplitude, if the signal is not clipped then the original signal is used. In a thirteenth embodiment the clipped “I” and “Q” signal are low pass filtered to remove unwanted signals. In a fourteenth embodiment a real signal is when the “Q” component of the complex signal does not exist and signal could be at baseband or at a higher frequency.

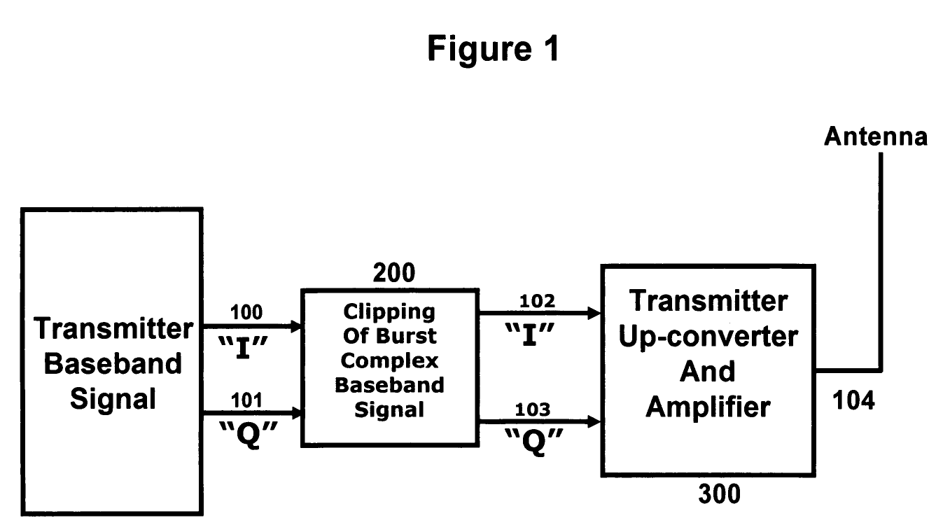

Referring to FIG. 1, an amplitude clipping function is illustrated. The clipping function receive its inputs from transmitter baseband signal 100. The output of the amplitude clipping function 200 could be up converted and amplified by other circuits 300. The amplitude clipping function performs the following functions:

1. Calculate the rolling average of the amplitude of the transmitter baseband output 100.

2. Calculate the instantaneous value of the amplitude of the transmitter baseband output 100.

3. Calculate the ratio of the instantaneous and rolling average of the complex signal amplitude.

4. Calculate the instantaneous phase of the transmitter baseband output 100.

5. Calculates the amount of the amplitude clipping of the transmitter baseband output 100.

6. Use a look up table to find the clipping amount based on ratio of the instantaneous and absolute value of the rolling average of the signal amplitude as well as absolute value of the rolling average of the amplitude.

7. Use a programmable delay to establish the presence and absence of the burst of complex or real signal.

8. Clip the amplitude of the transmitter output 100.

9. Filter the clipped “I” and “Q” signals to remove unwanted signals

10. Have a low pass filter with a bandwidth equal or higher than Nyquist bandwidth times one plus the roll off the original baseband filter.

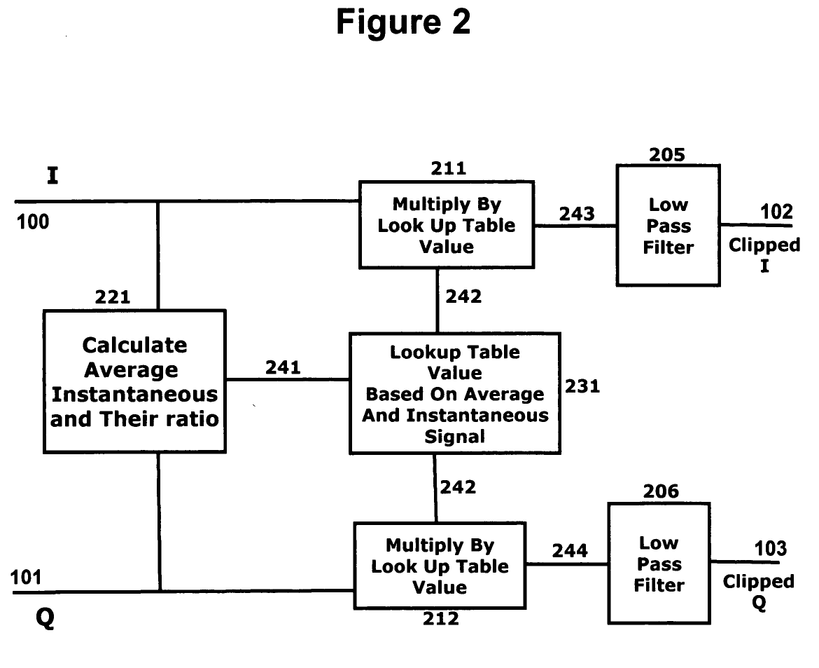

FIG. 2 illustrates the detail block diagram of the amplitude clipping function. The in phase “I” 100 and quadrature phase “Q” 101 components of the complex signal are used in block 221 to calculate the amplitude rolling average, instantaneous of the complex signal amplitude, the ratio of the instantaneous and rolling average, as well as absolute value of the amplitude rolling average. These for information 241 are used by look up table 231 to determine the clipping factor 242. The clipping factor 242 is multiplied to the “I” and “Q” signals in blocks 211, and 212 to produce the clipped “I” and “Q” signals 243, and 244. The clipped signals 243 and 244 are then low pass filtered by blocks 205 and 206 to produced clipped and filtered “I” and “Q” signals 102 and 103. The amplitude instantaneous value is used to determine the presence or absence of the burst by introducing a programmable delay due to number of samples per symbol which makes the resolution of the detection maximum one symbol period.

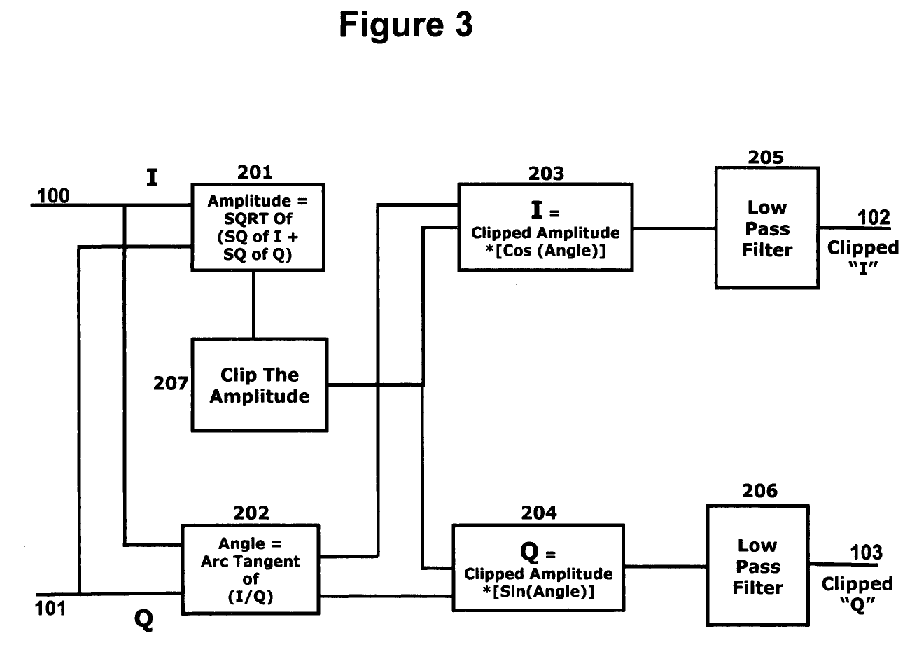

FIG. 3 illustrates the detail block diagram of an alternative amplitude clipping function. The in phase “I” 100 and quadrature phase “Q” 101 components of the complex signal are used in block 201 to calculate the instantaneous amplitude of the complex signal and in block 202 to calculate the instantaneous phase of the complex signal. The instantaneous amplitude is clipped in block 207 if it is more than a predefined threshold, and it will not be changed if it is less or equal to the threshold. The output of the blocks 207 and 202 are then applied to blocks 203 and 204 to calculate the new value for the in phase “I” and quadrature phase “Q” of the complex signal. The clipped s“I” and “Q” signals are then low pass filtered by blocks 205 and 206 to produced clipped and filtered “I” and “Q” signals 102 and 103.

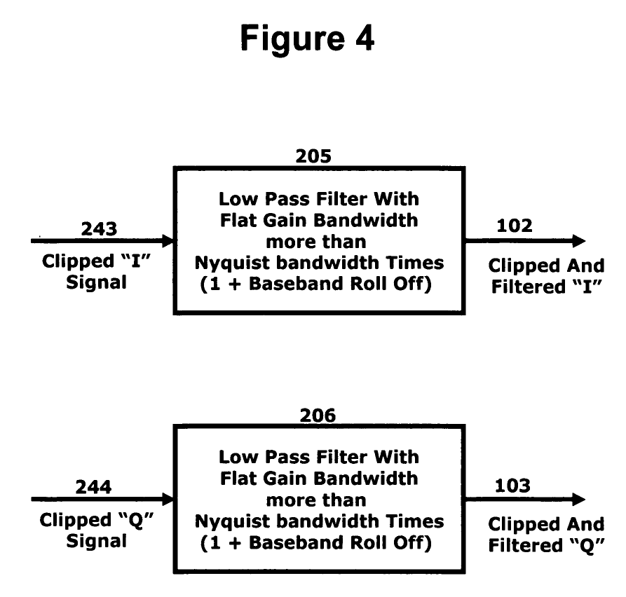

FIG. 4 shows the block diagram of the low pass filters. The low pass filters 205 and 206 are used to remove the unwanted signal from the clipped in phase 243 and quadrature phase 244 components of the complex signal. The bandwidth of the filters 205 and 206 should be more that the Nyquist bandwidth, at least more than Nyquist plus the roll off of the original low pass filter that has been applied to the “I” and “Q” signals. The filters 205 and 206 need to have flat amplitude and group delay for 98% of its bandwidth to avoid disturbing the clipped “I” and “Q” signals. The output of the low pass filters 205 and 206 are the clipped and unwanted signals free “I” 102 and “Q” 103 signals.

1. An amplitude clipping function for use with bursty complex and real signals with high crest factor or peak to average ratio. The amplitude clipping that results in reduction of the peak to average or crest factor of the signal and reduces the linearity requirement of the circuits that it is applied to. A technique to enhance the linearity and performance of the various electronic components, used in wireless cellular, PCS, wireless LAN, line of sight microwave, military, and satellite communication systems and any other none wireless applications, the amplitude clipping function comprising:
An amplitude clipping of any complex or real signal without disturbing the phase of the signal.
An amplitude clipping of complex or real signal at baseband or real signal at a high frequency.
An amplitude clipping of any complex or real signal based on the ratio of the instantaneous to rolling average of the signal's amplitude as well as the absolute of the amplitude's rolling average.
A look up table to determine the amount of the clipping based on the ratio of the instantaneous to rolling average of the amplitude of the complex or real signal and the absolute of the rolling average of the complex and real signal amplitude.
A multiplier function or circuit that multiplies the in phase “I” and quadrature phase “Q” of the complex signal by the clipping factor determined by the look up table.
A low pass filter that filters the unwanted signals from the in phase “I” and quadrature phase “Q” components of the complex signal.
A low pass filter with flat amplitude and group delay that avoid disturbing any wanted frequency which is in band of the complex or real signal.
A low pass filter with a bandwidth greater or equal the Nyquist bandwidth times one plus the roll off of the original root raise cosine baseband filter used to filter “I” and “Q” components.
A programmable delay that helps in determining the presence and absence of the bursty complex or real signal.
A rolling average calculator that operates only when the burst is presence.

2. The amplitude clipping function or circuit according to claim 1, wherein the signal from the transmitter baseband is complex and bursty.

3. The amplitude clipping function or circuit according to claim 1, wherein the bursty and complex baseband signal from the transmitter baseband has sufficient samples for clipping process to avoid any overlapping due to clipping function.

4. The amplitude clipping function or circuit according to claim 1, wherein the instantaneous value of the amplitude, rolling average of the amplitude, the ratio of the instantaneous and rolling average, and the rolling average absolute value is calculated at each sample received from the transmitter baseband.

5. The amplitude clipping function or circuit according to claim 1, wherein the rolling average of the amplitude, absolute value of the rolling average, and the ratio of the amplitude's instantaneous and amplitude's rolling average are calculated only during the presence of the complex signal burst.

6. The amplitude clipping function or circuit according to claim 1, wherein the ratio of the complex signal instantaneous amplitude and its amplitude's rolling average as well as rolling average absolute value are used by a look up table to determine the amount of the clipping.

7. The amplitude clipping function or circuit according to claim 1, wherein based on its inputs the look up table define one clipping factor value for both complex signal's in phase “I” and quadrature phase “Q” components.

8. The amplitude clipping function or circuit according to claim 1, wherein the look up table has three dimensions, two defined by the absolute of the rolling average and instantaneous of the complex signal amplitude and the third is the clipping factor used for clipping the complex signal.

9. The amplitude clipping function or circuit according to claim 1, wherein the clipping function is a simple multiplier with “I” or “Q” as one input and the clipping factor as the second input.

10. The amplitude clipping function or circuit according to claim 1, wherein in phase “I” and quadrature phase “Q” components of the complex signal after being clipped are low pass filtered to remove any unwanted signal created by clipping function.

11. The amplitude clipping function or circuit according to claim 1, wherein the low pass filters used to remove the unwanted signals have flat amplitude and group delay for a bandwidth that occupied 99% of the wanted signals in “I” and “Q” components.

12. The amplitude clipping function or circuit according to claim 1, wherein the amplitude clipping function can also be applied to real signals at baseband or higher frequencies.

13. The amplitude clipping function or circuit according to claim 1, wherein the amplitude clipping at frequencies different than baseband requires band pass filtering instead of low pass.

14. The amplitude clipping function or circuit according to claim 1, wherein amplitude clipping can be implemented in digital and analog domain.

15. The amplitude clipping function or circuit according to claim 1, wherein a programmable delay is used during each symbol to determine the presence and absence of the burst.

16. The amplitude clipping function or circuit according to claim 1 and subsequent claims, when it is used in wireless cellular, wireless PCS, wireless LAN, microwave, wireless satellite, none wireless amplifiers, and any wireless communication systems used for military applications.

17. The amplitude clipping function or circuit according to claim 1, wherein the signal processing function can be implemented in programmable logic, FPGA, Gate Array, ASIC, and DSP processor
